(19) United States
(12) Patent Application Publication
(10) Pub. No.: US 2025/0331664 A1
(43) Pub. Date: Oct. 30, 2025

(54) A CONTAINER FOR A SUBSTANCE

(71) Applicant: Jonathan CONOHAN, MANOTICK (CA)

(72) Inventor: Jonathan CONOHAN, MANOTICK (CA)

(21) Appl. No.: 18/866,971

(22) PCT Filed: May 19, 2023
(86) PCT No.: PCT/CA2023/050698

§ 371 Date: Nov. 18, 2024

Related U.S. Application Data
(60) Provisional application No. 63/344,228, filed on May 20, 2022.

(51) Int. Cl. A47G 19/22; G10K 9/02

(52) U.S. Cl. CPC A47G 19/2227; G10K 9/02; A47G 2019/2244

(57) ABSTRACT

The present invention describes a container which is capable of creating a sound through the displacement of air within a channel and sound ports in the container.

### FIELD OF THE INVENTION

The present invention pertains to the field of containers and more specifically to a container for a substance which can produce a sound.

### BACKGROUND OF THE INVENTION

Noise makers come in various forms and attempts have been made to incorporate such noise makers in various items. There is a need for a container which can produce a noise or sound which is incorporated within a container to provide a noise or sound on demand.

### SUMMARY OF THE INVENTION

The present invention provides a container for a substance comprising a vessel to receive the substance and a shell interconnected to the vessel having a channel for passage of air within the channel. The container also has a port in fluid communication with the channel and a bladder positioned on the shell to produce a sound when air is displaced in the channel.

### BRIEF DESCRIPTION OF THE DRAWINGS

The embodiments of the present invention will now be described by reference to the following figures, in which identical reference numerals in different figures indicate identical elements and in which:

FIG. 1A is a perspective view of a container according to one embodiment of the present invention;

FIG. 1B is a top perspective view of a container according to one embodiment of the present invention;

FIG. 2A is a bottom perspective view of a container according to one embodiment of the present invention;

FIG. 2B is a bottom perspective view of a container with a bottom cap with openings according to one embodiment of the present invention;

FIG. 3 is a bottom perspective view of a container with a bladder according to one embodiment of the present invention;

FIG. 4 is a cross-section view of a container according to one embodiment of the present invention;

FIG. 5 is a cross-section view of the bottom portion of a container with a bladder according to one embodiment of the present invention;

FIG. 6 is a cross-section view of the bottom portion of a container with a bladder without a bottom cap according to one embodiment of the present invention;

FIG. 7 is a cross-section view of the bottom portion of a container without a bladder according to one embodiment of the present invention;

FIG. 8 is a perspective view of a vessel and a cross-section view of a shell according to one embodiment of the present invention;

FIG. 9 is a cross-section view of a port in fluid communication with a channel positioned in a container according to one embodiment of the present invention;

FIG. 10 is a perspective view of a container according to another embodiment of the present invention;

FIG. 11 is a sectional view of a container in the form of a mug according to another embodiment of the present invention;

FIG. 12 is a sectional perspective view of a container in the form of a mug according to another embodiment of the present invention;

FIG. 13 is a sectional view of a container in the form of a mug without a support according to another embodiment of the present invention; and

FIG. 14 is a perspective view of a container according to another embodiment of the present invention;

FIG. 15 is a top view of a container according to another embodiment of the present invention;

FIG. 16 is a top view of a container according to another embodiment of the present invention without a cover;

FIG. 17 is an exploded view of a container according to another embodiment of the present invention without a cover;

FIG. 18 is a cross section view of a container according to another embodiment of the present invention;

FIGS. 19 and 19a are cross section views of the bottom portion of a container according to another embodiment of the present invention;

FIG. 20 is a top perspective view of a container according to another embodiment of the present invention; and

FIG. 21 is a cross-sectional view of a container having a sound member within a channel according to another embodiment of the present invention;

FIG. 22 is another sectional view of a container having a sound member within a channel according to another embodiment of the present invention;

FIG. 23 is a perspective view of a container holder according to another embodiment of the present invention;

FIG. 24 is another perspective view of a container holder according to another embodiment of the present invention;

FIG. 25 is a cross sectional view of a container holder according to another embodiment of the present invention;

FIG. 26 is a cross sectional view of the bottom portion of a container holder according to another embodiment of the present invention;

FIG. 27 is a perspective view of a container according to another embodiment of the present invention;

FIG. 28 is another perspective view of a container according to another embodiment of the present invention; and

FIG. 29 is a cross-sectional view of a sealable cap for use with another embodiment of the present invention as shown in FIGS. 27 and 28.

The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention.

### DETAILED DESCRIPTION OF THE INVENTION

The terms “coupled” and “connected”, along with their derivatives, may be used herein. It should be understood that these terms are not intended as synonyms for each other. Rather, in particular embodiments, “connected” may be used to indicate that two or more elements are in direct physical or electrical contact with each other. “Coupled” may be used to indicated that two or more elements are in either direct or indirect (with other intervening elements between them) physical or electrical contact with each other, or that the two or more elements co-operate or interact with each other (e.g. as in a cause and effect relationship).

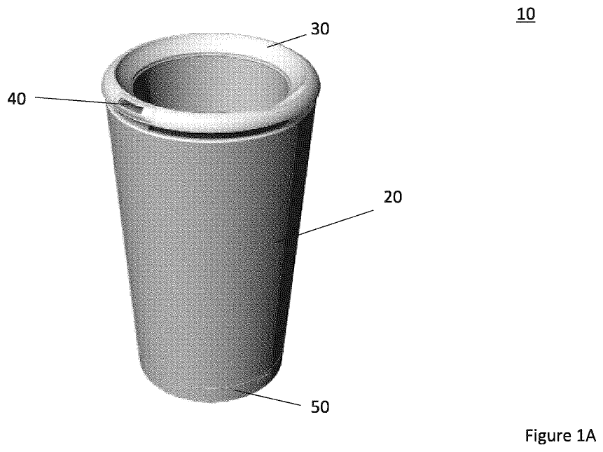

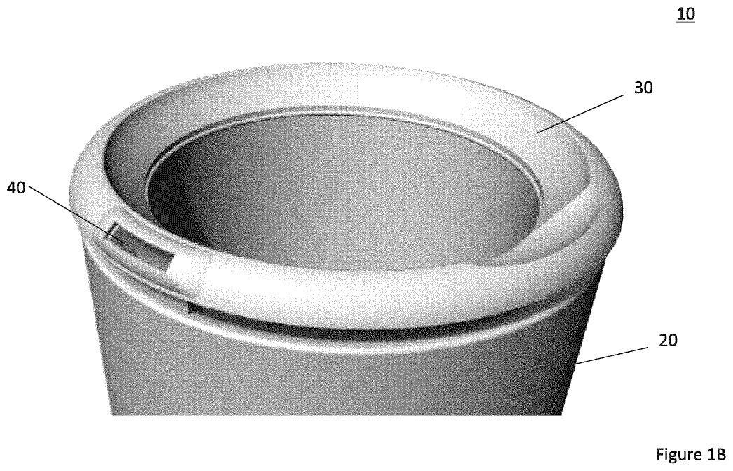

With reference to FIGS. 1A and 1B and according to one embodiment of the present invention, a container 10 is shown having a shell 20 and a vessel 30. A port 40 is positioned on vessel 30 allowing for fluid communication with a channel (not shown). Container 10 also has a cap 50 secured to the bottom of container 10 which bottom cap 50 secures a bladder (not shown) to container 10.

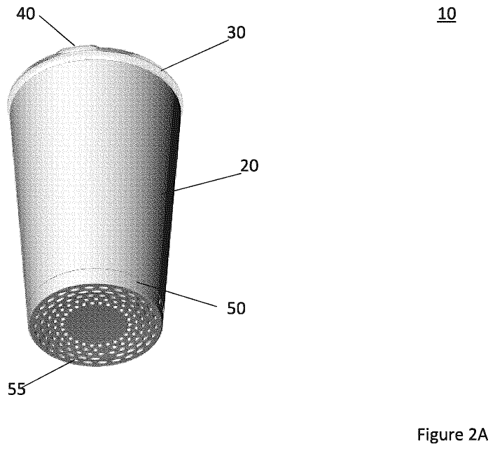

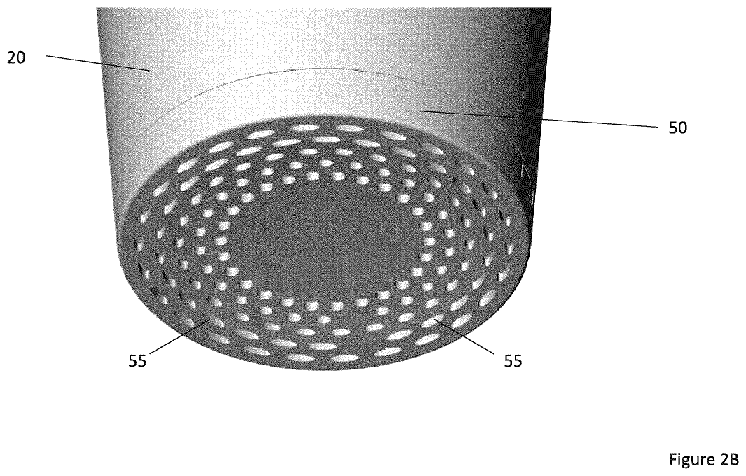

With reference to FIGS. 2A and 2B and according to one embodiment of the present invention, cap 50 is shown secured to container 10. Cap 50 has openings 55 allowing for the passage of air which in turns allows the bladder (not shown) to move and in turn creates a sound or noise. Openings 55 can be numerous as shown on bottom cap 50 or can consist of only a few protrusions. The shape of the protrusions can vary and only requires air to travel through bottom cap 50 which allows movement of the bladder.

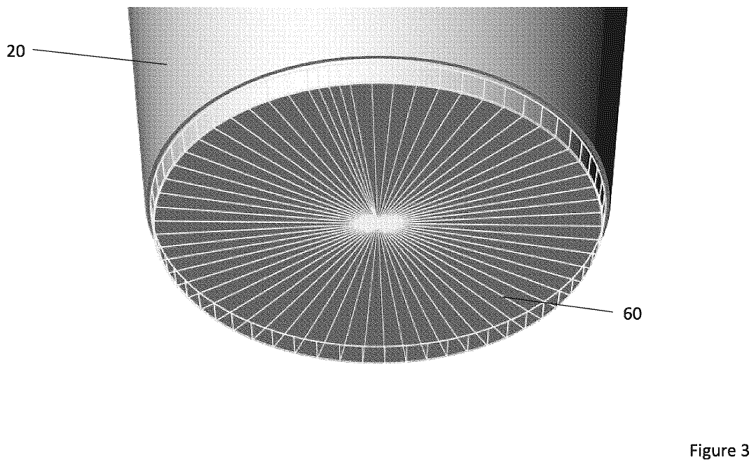

With reference to FIG. 3 and according to one embodiment of the present invention, a bladder 60 is shown positioned on the bottom portion of a container. The bladder 60 (shown as a web for illustrative purpose only) is secured to the container through the use of the bottom cap (not shown) and allows for a sound to be produced as will be further described below. Bladder 60 is a solid membrane which can be made of a rubber material or a reed or any other material which will produce a sound or noise.

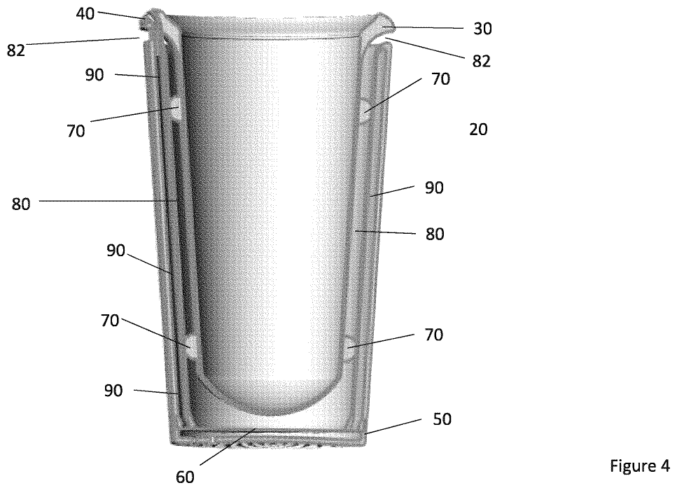

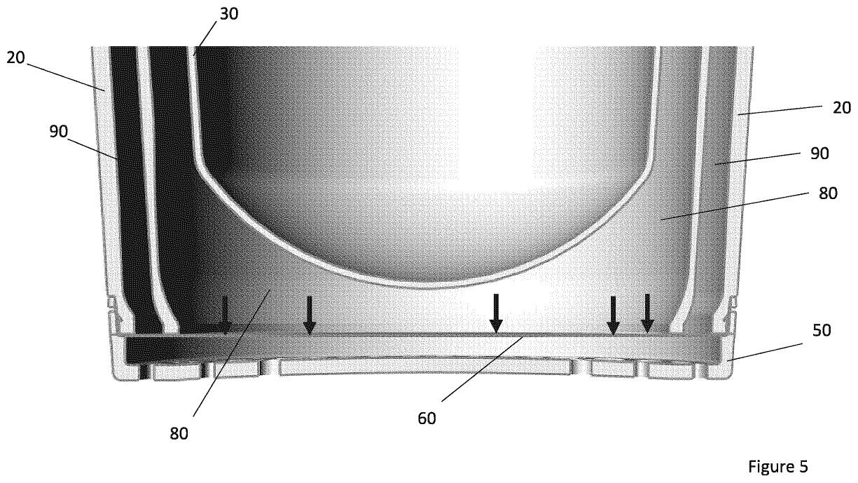

With reference to FIG. 4 and according to one embodiment of the present invention, container 10 is shown having shell 20 and vessel 30 with bottom cap 50. Shell 20 is interconnected to vessel 30 through ribs 70 providing a gap 80 between shell 20 and vessel 30. Ribs 70 can consist of simple protrusions or any other spacer as would be known by a worker skilled in the relevant art allowing for a gap to be present between shell 20 and vessel 30. Shell 20 also has a channel 90 in fluid communication with port 40 with said channel 90 traveling along the length of shell 20.

With reference to FIGS. 4 and 5 and according to one embodiment of the present invention, channel 90 allows for the travel of air to bladder 60 secured to the bottom portion of container 10. Once air impacts bladder 60, the bladder will move in a downward manner allowing air to pass on top of bladder 60 and into gap 80. The movement of bladder 60 is required in order to produced a noise or sound with air entering gap 80 and exiting through sound port 82. Sound port 82 can be of varying width and the variation of this width will impact the noise or sound produced by the container. The movement of bladder 60 when air travels in channel 90 is shown through the arrows in FIG. 5. Sound port 82 can surround the top portion of the container except where port 40 is positioned on the container.

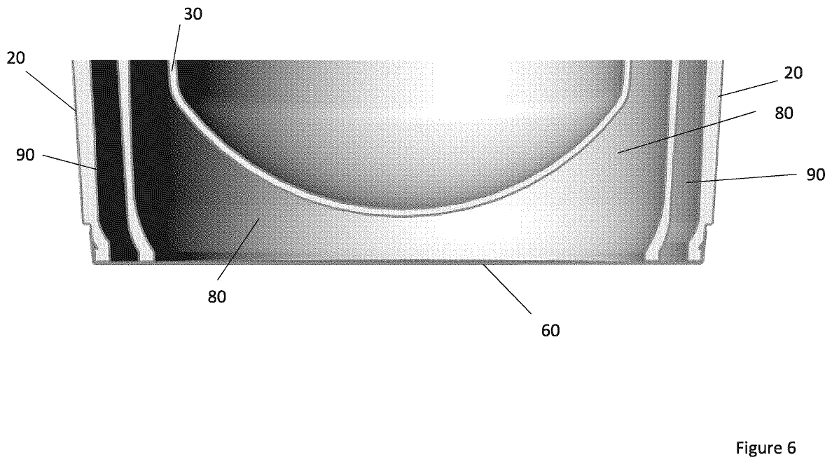

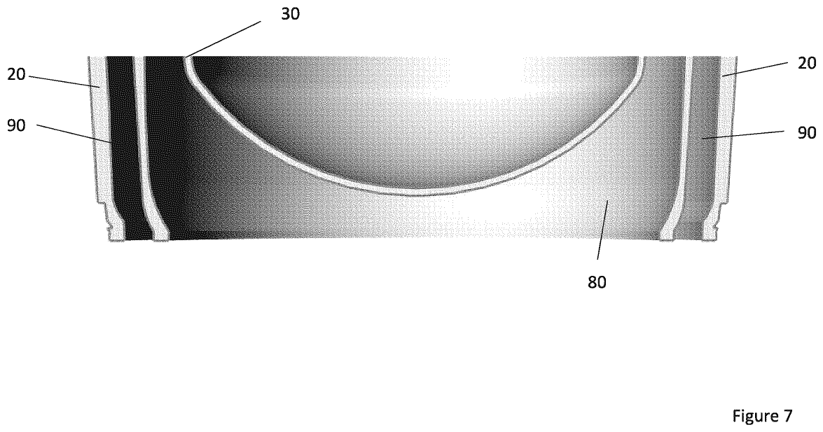

With reference to FIGS. 6 and 7 and according to one embodiment of the present invention, bottom portion of container 10 is shown with and without the bladder positioned on the container. FIG. 6 shows bladder 60 positioned on the container with the outer edges of bladder 60 overlapping the edges of shell 20. The bladder may consist of an elastic material made from silicone, synthetic rubber, neoprene rubber or any other elastomer product as would be known by a worker skilled in the relevant art. The bladder 60 must allow for movement and vibration of the bladder when air is applied to the bladder. Such vibration or movement will in turn produce a sound. The sound will travel either through the bottom cap (not shown) or within the gap 80 between vessel 30 and shell 20.

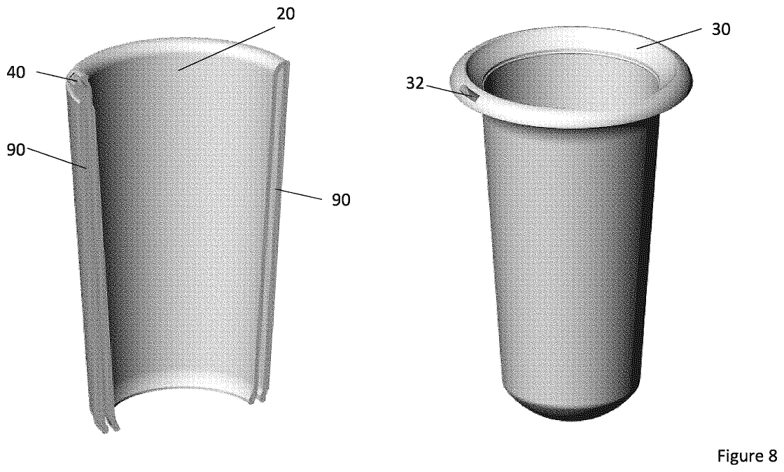

With reference to FIG. 8 and according to one embodiment of the present invention, a cross- section of a shell 20 and a vessel 30 as would be used in a container is shown. Vessel 30 has a port adapter 32 for interconnecting with port 40 on shell 20. In another embodiment, vessel 30 may not have port adapter 32 as port 40 can be solely positioned on shell 30.

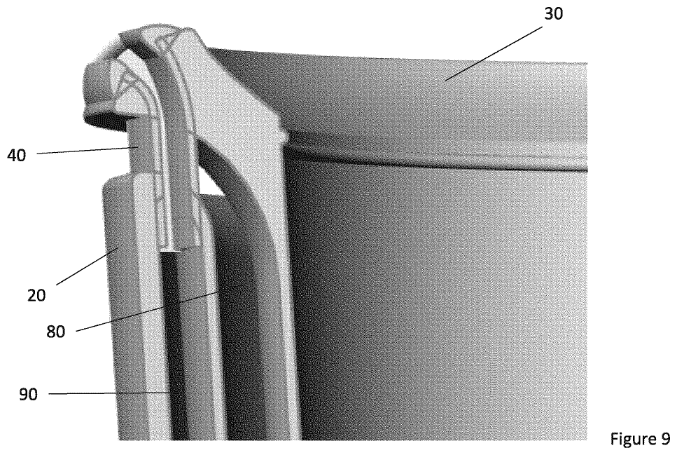

With further reference to FIG. 8 and according to one embodiment of the present invention, air can travel within channel 90 of shell 20 when air is applier to port 40. Movement of air within channel 90 will provide a pressure on the bladder (not shown) positioned on the bottom portion of the container through the bottom cap (not shown). Arrows in FIG. 9 illustrate the displacement of air within channel 90 to reach the bladder.

With reference to FIG. 9 and according to one embodiment of the present invention, port 40 is shown in fluid communication with channel 90 of shell 20. Port 40 can be part of vessel 30 as shown or can be independent of vessel 30 such that port 40 is not connected or in contact with vessel 30. Port 40 can be a separate component positioned on top of channel 90 or can be uniformed with channel 90.

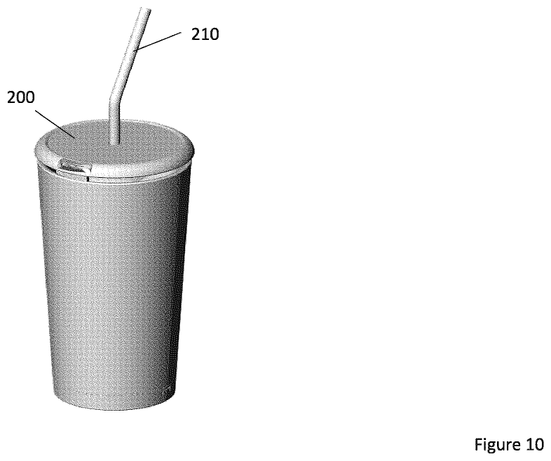

With reference to FIG. 10 and according to another embodiment of the present invention, a container is shown with a cover 200 and a straw 210. Cover 200 can cover or not cover port 40, however, if cover 200 covers port 40 then a sound cannot be produced.

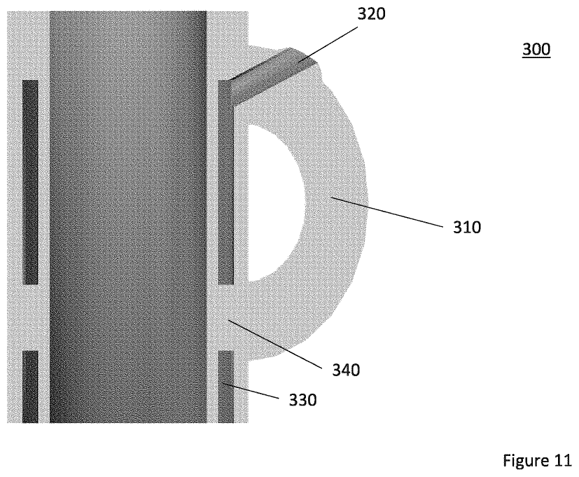

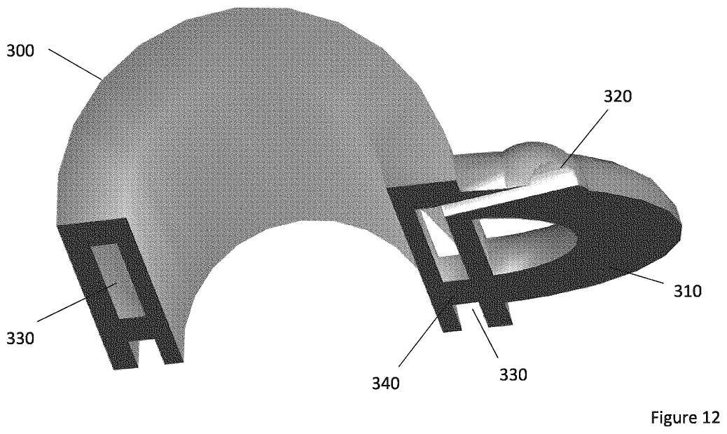

With reference to FIGS. 11 and 12 and according to another embodiment of the present invention, a container is shown in the form of a mug 300 having a handle 310 with a port 320 on handle 310. Port 320 allows for air to be in fluid communication with channel 330. Air will travel in channel 330 to the bottom of mug 300 in order to create a sound through the use of a bladder (not shown) but described above. Support 340 is present within channel 330 for structural integrity of the container since channel 330 surrounds container 300. With specific reference to FIG. 12 and according to one embodiment of the present invention, support 340 is shown as a single solid piece which does not surround the container within channel 330.

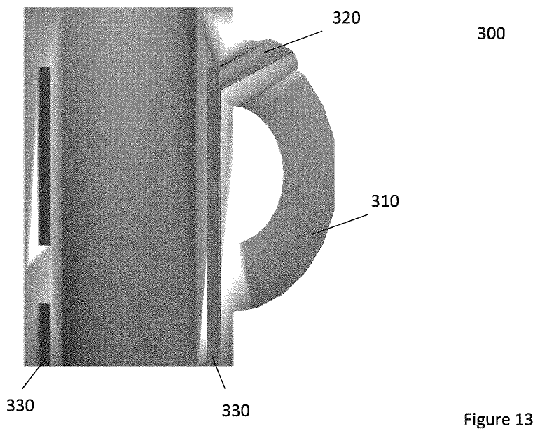

With reference to FIG. 13 and according to one embodiment of the present invention, a container 300 is shown without the presence of support 340 near handle 310 and in channel 330 near handle 310.

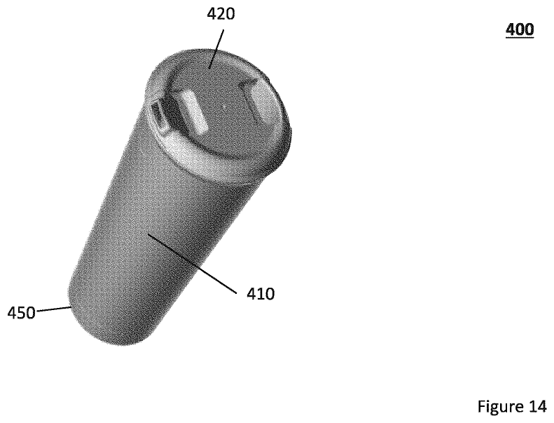

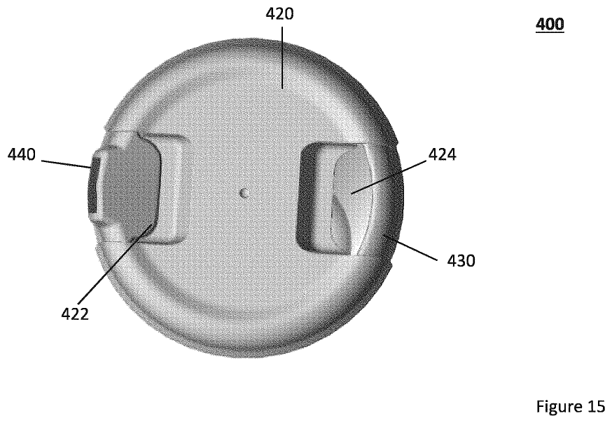

With reference to FIGS. 14 and 15 and according to another embodiment of the present invention, a container 400 is shown. The container 400 has a shell 410 and a cover 420. A bottom cap 450 is also shown allowing to secure a bladder (not shown) within the container 410. With further reference to FIG. 15, cover 420 has two opening namely a port opening 422 and a liquid port opening 424 allowing for the drinking of a substance within the container.

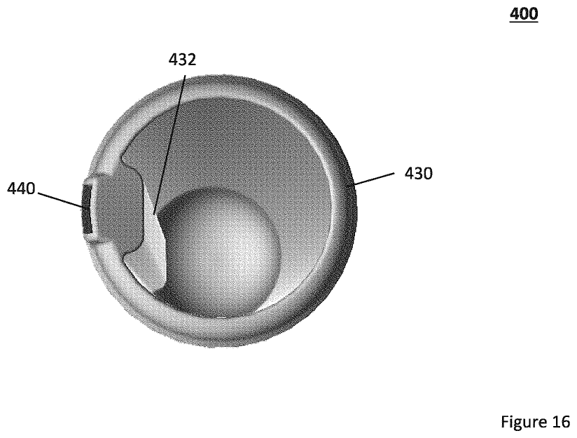

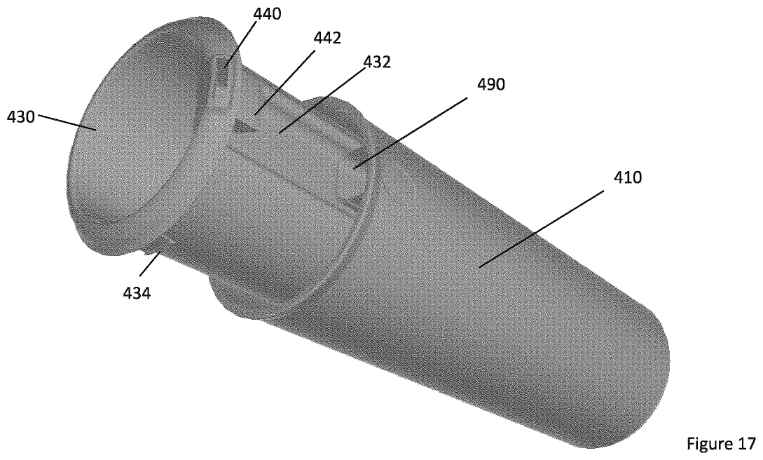

With reference to FIGS. 16 and 17 and according to another embodiment of the present invention, a container 400 is shown without a cover. Port 440 is shown connected to vessel 430 allowing for a fluid communication with a channel 490 which travels the length of the shell 410. Vessel 430 has indentation 432 which overlaps with the channel positioned within the outer shell of the container. With specific reference to FIG. 17, vessel 430 is shown displaced from within shell 410 as vessel 430 is secured to shell 410 through the use of clips 434. Other means to secure vessel 430 to shell 410 could be used such as a snap fit or any other method of fastening a vessel to an outer shell as would be known by a worker skilled in the relevant art. With vessel 430 displaced from shell 410, channel 490 can be seen as positioned within shell 410. Port 440 is also shown wherein the port has a male component 442 allowing it to be positioned within channel 490 allowing port 440 to be in fluid communication with channel 490 when vessel 430 is secured to shell 410.

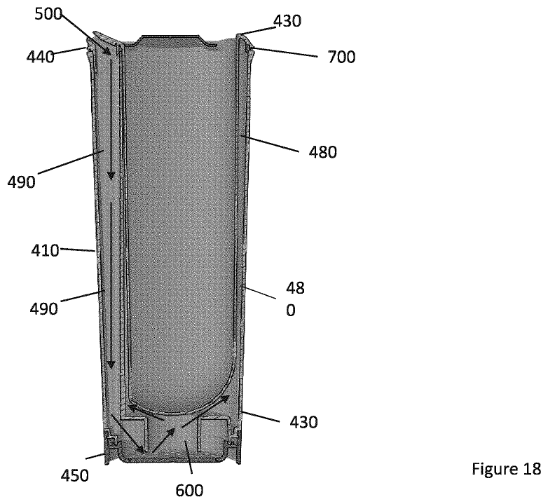

With reference to FIG. 18 and according to one embodiment of the present invention, a cross- section view of a container 400 is shown. Container 400 has shell 410 and cover 420 secured to vessel 430. Channel 490 is shown is shown within shell 410 with channel 490 traveling the entire length of shell 410. Arrows 500 within channel 490 display the travel of air within channel 490 when air is pushed through port 440. Air will travel into channel 490 until it reached the bottom portion of shell 410 and will then exit through central opening 600 for travel within gap 480 present between vessel 430 and shell 410. As the air travels within gap 480 this will allow the air to exit the container through a sound portal 700 at the top of container 400. The presence of a bladder is required in order to produce a sound within gap 480 which bladder is further described below.

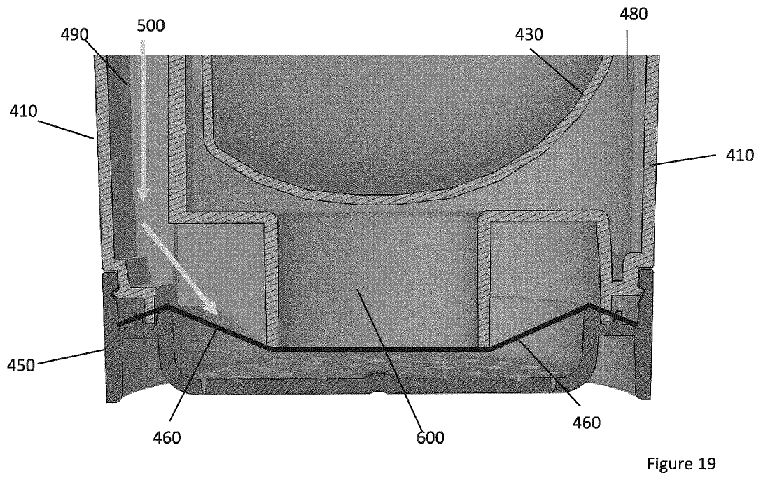

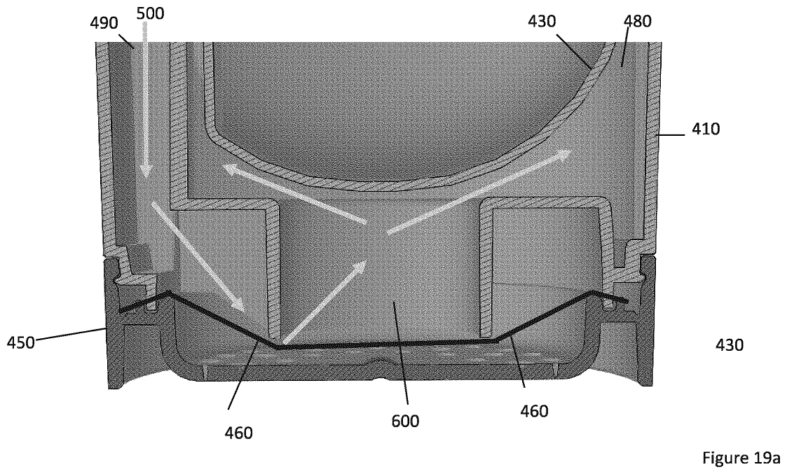

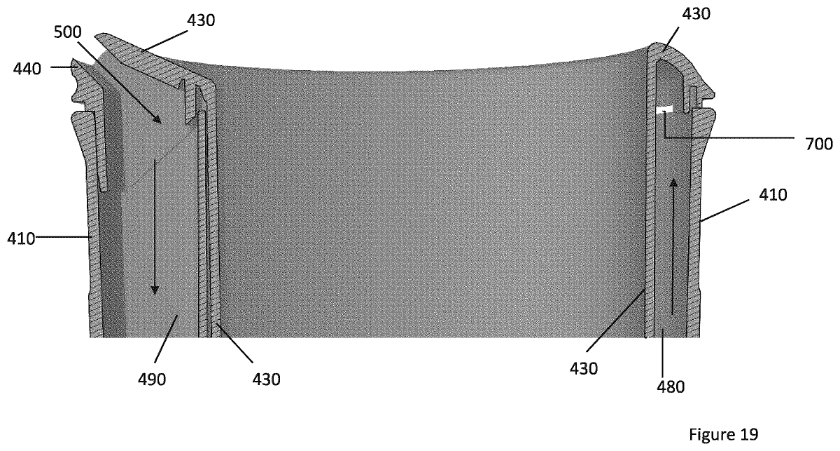

With reference to FIGS. 18 and 19 and according to one embodiment of the present invention, a bladder 460 is shown positioned within the bottom portion of the container. Bladder 460 is secured to the container through bottom cap 450 being threaded onto shell 410. With specific reference to FIG. 19, air (shown by the arrows 500) enters the container from port 440 and into channel 490 which channel is isolated from vessel 430 and gap 480. The isolation of channel 430 and gap 480 is required in order to produce a sound or noise. Air travels into port 440 and within gap 480 and exits through sound portal 700. The movement of the bladder allows air to travel into gap 480 which creates the noise or sound from the container.

With further reference to FIG. 19a, as air travels (shown by arrows 500) through channel 490 said air will impact bladder 460 and push bladder 460 downward allowing air to enter central opening 600. The movement of bladder 460 produces the sound which travels through channel 480 and exits through sound portal 700.

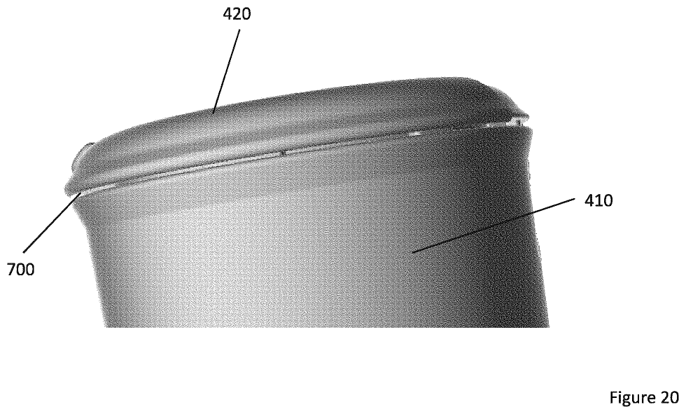

With reference to FIG. 20 and according to another embodiment of the present invention, sound portal 700 is shown as a small gap between vessel 430 positioned within shell 410. The width opening of sound portal 700 will have an impact on the noise or sound produced by the container.

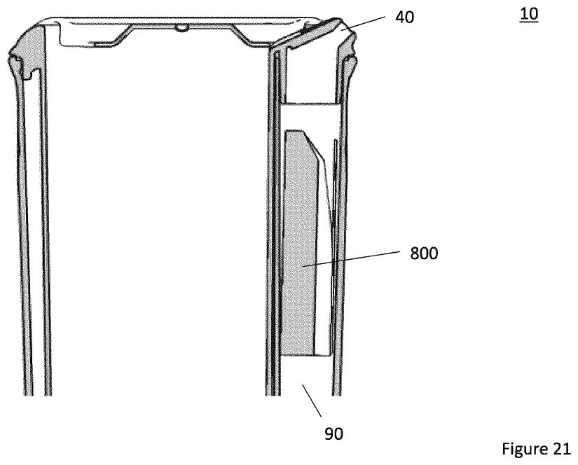

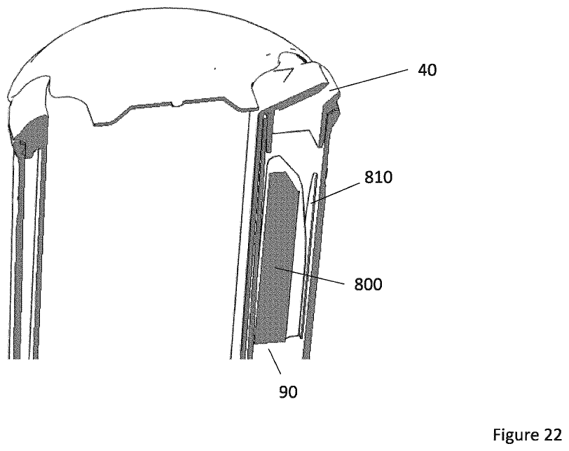

With reference to FIGS. 21 and 22 and according to another embodiment of the present invention, a container 10 is shown having a sound member 800 which allows for the creation of a certain sound for example a duck call among other sounds possible based on sound member 800. Sound member 800 is positioned within channel 90 which is in fluid communication with port 40. The introduction of air within port 40 will allow air to travel to sound member 800 producing a sound when the air exits container 10 as described above in other embodiments.

With further reference to FIG. 22 and according to another embodiment of the present invention, sound member 800 has tongue 810 which can move and vibrate creating a sound which could be similar to a duck call or any other type of sound which can be produced through a tongue member. In order to create a certain sound in the container of the present invention sound member needs to be fixed within channel 90 with fluid communication to port 40. Sound member 800 only needs to vary the travel of air within channel 90 to create a sound allowing for a number of variations of sound member 800 to create different sounds. For example, the shape, presence of a tongue or not will have an impact on the sound produced by the container.

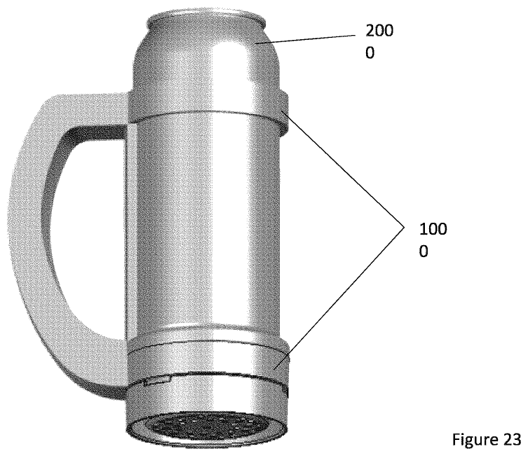

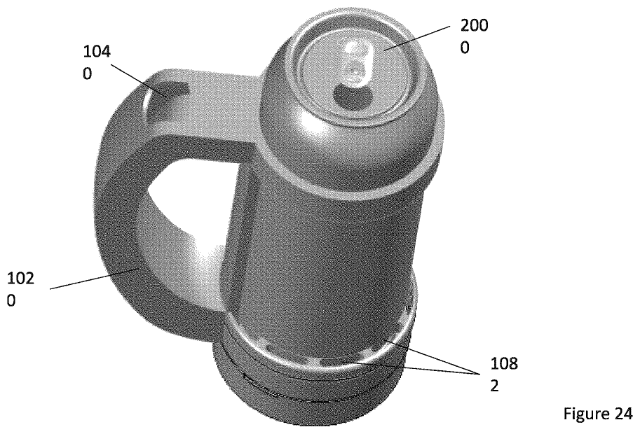

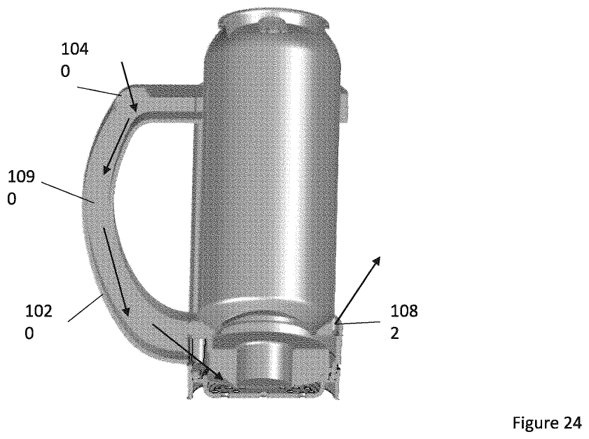

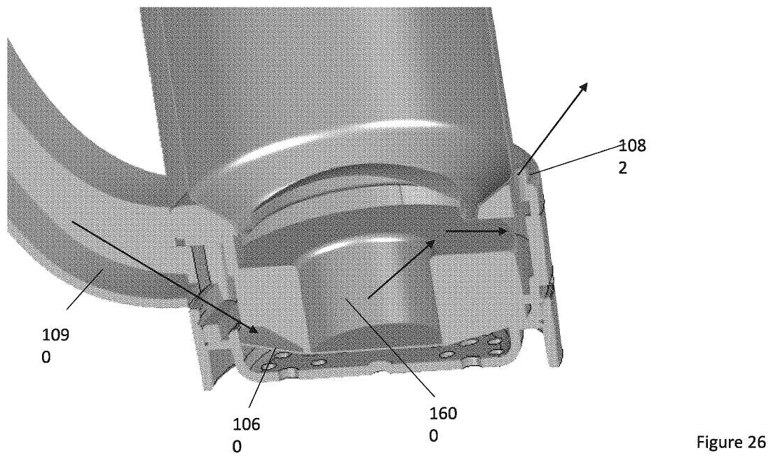

With reference to FIGS. 23 and 24 and according to another embodiment of the present invention, a container holder 1000 for holding a can 2000 is shown. Container holder 1000 has a port 1040 within handle 1020. Sounds ports 1082 are present on the bottom portion of container holder 1000. When air is introduced in port 1040 and travels to sound ports 1082 and a sound is produced. Air travel is shown through the presence of arrows in FIG. 24 for example. Container holder 1000 can also hold a number of other containers other than can. With further reference to FIGS. 25 and 26 and according to one embodiment of the present invention, container holder 1000 has channel 1090 within handle 1020 in fluid communication with port 1040 allowing air to travel to bladder 1060 wherein bladder 1060 is displaced allowing air to travel into central opening 1600 to then exit through sound ports 1082.

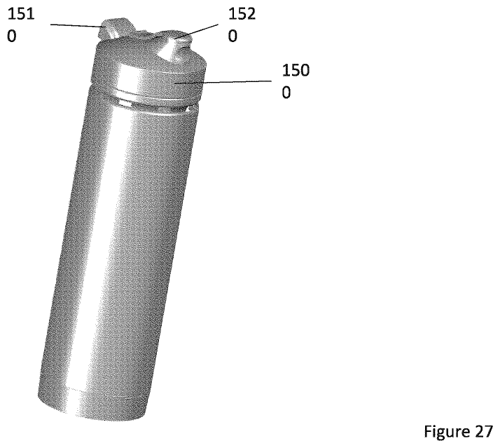

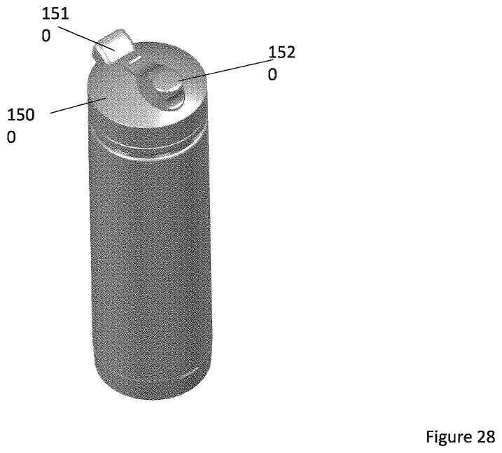

With reference to FIGS. 27 and 28 and according to another embodiment of the present invention a container 10 is shown having a sealable cap 1500. Container 10 has port 1510 allowing air to be in fluid communication with a channel within container 10 as described above in other embodiments. Port 1510 and liquid port 1520 are positioned on sealable cap 1500. Liquid port 1520 allows for a liquid to be consumed by a user and can have a closable feature allowing to seal liquid port 1520.

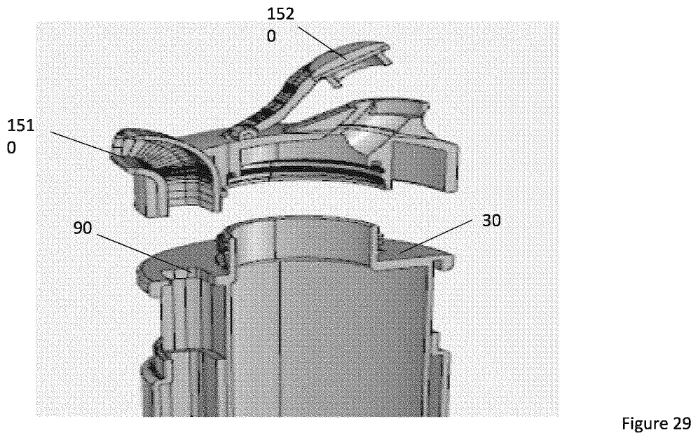

With reference to FIG. 29 and according to another embodiment of the present invention, sealable cap 1500 is secured to container 10 through a threaded engagement positioned on vessel 30. As sealable cap 1500 is positioned on container 10 and threaded onto vessel 30, port 1510 will align with channel 90 allowing fluid communication with port 1510.

In another embodiment of the present invention, the outer shell of the container may contain one or more holes allowing to vary the sound or noise produced by the container. In order to vary the noise or sound from the container, the holes need to be positioned on the outer surface of the shell of the container as described in the accompanying Figures or in contact with gap 80 or 480.

The present invention can contain a number of containers having ports located within different locations on the container as long as the port is in fluid communication with the channel and bladder.

A container of the present invention could be made from a number of different materials such as plastic, paper, glass or any other material as would be known by a worker skilled in the relevant art.

A person understanding this invention may now conceive of alternative structures and embodiments or variations of the above all of which are intended to fall within the scope of the invention as defined in the claims that follow.

What is claimed is:

1. A container for a substance capable of producing a sound comprising:
a vessel for receiving the substance;
a shell interconnected to the vessel having a channel for passage of air within the channel;
a port in fluid communication with the channel;
a bladder positioned on the shell to produce the sound when air is displaced in channel; and,
a gap between the shell and the vessel allowing for the sound to escape from the container.
